(19) United States
(12) Patent Application Publication
(10) Pub. No.: US 2026/0259841 A1
(43) Pub. Date: Sep. 3, 2026

(54) SYSTEM AND METHOD FOR ENABLING DATA TRANSFER

(71) Applicant: JIO PLATFORMS LIMITED, Ahmedabad (IN)

(72) Inventors: Santosh Herald PINTO, Navi Mumbai, Maharashtra (IN); Irshad ALI, Varthur, Bangalore, Karnataka (IN); Rohit Jatashanka MISHRA, Thane, Maharashtra (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad (IN)

(21) Appl. No.: 18/878,676

(22) PCT Filed: Aug. 30, 2023
(86) PCT No.: PCT/IB2023/058548

§ 371 Date: Dec. 24, 2024

(30) Foreign Application Priority Data
Aug. 30, 2022 (IN) 202221049588

(51) Int. Cl. G06F 13/24

(52) U.S. Cl. CPC G06F 13/24; G06F 2213/0026

(57) ABSTRACT

The present disclosure relates to a system and a method for data transfer, and more specifically, to a system and a method for data transfer between a host NXP processor and a Radio Frequency System-on-Chip (RFSoC) using a PCIe bus. The method includes determining that data is set for transmission from a first processor to a second processor. The method includes copying the data to at least one memory address of the first processor based on the determination. The method includes triggering an inter-processor interrupt (IPI) over at least one channel of the second processor in response to the copying of the data. The method includes transmitting the data from the first processor to the second processor via the IPI.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to systems and methods for wireless telecommunication systems. More particularly, the present disclosure relates to a system and a method for data transfer.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Currently, Application Programming Interfaces (APIs) are used to determine a process of decoding messages that are being transmitted from and received by a processor from a NXP processor via a Peripheral Component Interconnect (PCI) bus and vice versa. Decoding messages being transmitted and received by the processor from the NXP processor via the PCI bus involves determining a communication protocol and interpreting the data being exchanged.

Conventional systems and methods access a data structure directly from a system memory. The data structure may include configuration parameters stored in one or more registers. The conventional systems and methods may configure an interconnect based on the configuration parameters to communicate or perform data transfer between one or more devices or processors. However, the conventional systems and methods do not ensure error-free transfer of data between the one or more devices or the processors.

There is, therefore, a need in the art to provide a system and a method to enable an error-free communication between the two processors in a communication system, leading to successful exchange of data messages.

### OBJECTS OF THE PRESENT DISCLOSURE

It is an object of the present disclosure to enable data transfer between processors, for example, from a host processor to a Radio Frequency System-on-Chip (RFSoC) over a Peripheral Component Interconnect (PCI) bus.

It is an object of the present disclosure to establish a communication channel for transfer of data packets between two processors via a Peripheral Component Interconnect express (PCIe) bus.

It is an object of the present disclosure to allocate a memory or a memory address to copy data or data packet set for transmission from one processor to another processor, and transfer the data or the data packets based on the memory address.

It is an object of the present disclosure to generate and trigger an inter-processor interrupt (IPI) over a channel of the processor, thereby ensuring successful transfer of the data.

It is an object of the present disclosure to provide a synchronized data transfer mechanism at a high speed without any data loss.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for data transfer. The system includes processors, and a memory operatively coupled to the processors, where the memory stores instructions to be executed by the processors. A first processor of the processors is configured to determine that data is set for transmission from the first processor to a second processor of the processors. The first processor is configured to copy the data to at least one memory address of the first processor based on the determination. The at least one memory address of the first processor is directly mapped with at least one memory address of the second processor. Further, the first processor is configured to trigger an inter-processor interrupt (IPI) over at least one channel of the second processor in response to the copying of the data. The first processor is configured to transmit the data to the second processor via the IPI.

In an embodiment, the memory may include processor-executable instructions, which on execution, cause the first processor to receive an acknowledgement in a form of a Message Signalled Interrupt (MSI) over the at least one channel of the second processor, once the second processor receives the data from the first processor.

In an embodiment, the processor may trigger the IPI over the at least one channel of the second processor by establishing a connection between the first processor and the second processor once the data is copied, generating the IPI based on the established connection, and triggering the IPI over the at least one channel of the second processor.

In an embodiment, the processor may generate the IPI by determining that a transport layer of the first processor fills a Downlink (DL) buffer region with a message indicating that the data is set for transmission from a Double Data Rate (DDR) region mapped to a Peripheral Component Interconnect Express (PCIe) Base Address Register (BAR) 0 of the second processor.

In an embodiment, the at least one memory address of the first processor may correspond to a Double Data Rate (DDR) region, and wherein the at least one memory address of the second processor may correspond to a Peripheral Component Interconnect Express (PCIe) Base Address Register (BAR) 0.

In an embodiment, the memory may include processor-executable instructions, which on execution, cause the first processor to store the data in a buffer region. In an embodiment, the buffer region may include at least one of a downlink (DL) buffer region, a DL queue region, a DL queue control region, a slot indication region, an uplink (UL) buffer region, an UL queue region, and an UL queue control region.

In an embodiment, the DL queue region may provide pointers to indicate a memory address of the data to be transmitted upon generation of the IPI.

In an embodiment, the first processor may be a Layer 2/Layer3 (L2/L3) NXP processor, and the second processor may be a Layer 1 (L1) processor.

In an aspect, the present disclosure relates to a method for data transfer. The method includes determining, by a first processor associated with a system, that data is set for transmission from the first processor to a second processor. The method includes copying, by the first processor, the data to at least one memory address of the first processor based on the determination. The at least one memory address of the first processor is directly mapped with at least one memory address of the second processor. The method includes triggering, by the first processor, an inter-processor interrupt (IPI) over at least one channel of the second processor in response to the copying of the data. The method includes transmitting, by the first processor, the data to the second processor via the IPI.

In an embodiment, the method may include receiving, by the first processor, an acknowledgement in a form of a Message Signalled Interrupt (MSI) over the at least one channel of the second processor, once the second processor receives the data from the first processor.

In an embodiment, triggering, by the first processor, the IPI over the at least one channel of the second processor may include establishing, by the first processor, a connection between the first processor and the second processor once the data is copied, generating, by the first processor, the IPI based on the established connection, and triggering, by the processor, the IPI over the at least one channel of the second processor.

In an embodiment, the method may include generating the IPI by determining that a transport layer of the first processor fills a Downlink (DL) buffer region with a message indicating that the data is set for transmission from a Double Data Rate (DDR) region mapped to a Peripheral Component Interconnect Express (PCIe) Base Address Register (BAR) 0 of the second processor.

In an embodiment, the at least one memory address of the first processor may correspond to a Double Data Rate (DDR) region, and the at least one memory address of the second processor may correspond to a Peripheral Component Interconnect Express (PCIe) Base Address Register (BAR) 0.

In an embodiment, the method may include storing the data in a buffer region. In an embodiment, the buffer region may include at least one of a DL buffer region, a DL queue region, a DL queue control region, a slot indication region, an uplink (UL) buffer region, an UL queue region, and an UL queue control region.

In an embodiment, the DL queue region may provide pointers to indicate a memory address of the data to be transmitted upon generation of the IPI.

In an aspect, a non-transitory computer readable medium including processor-executable instructions cause a first processor to determine that data is set for transmission from the first processor to a second processor. The first processor is configured to copy the data to at least one memory address of the first processor based on the determination. The at least one memory address of the first processor is directly mapped with at least one memory address of the second processor. The first processor is configured to trigger an inter-processor interrupt (IPI) over at least one channel of the second processor once the data is copied. Further, the first processor is configured to transmit the data to the second processor via the IPI.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

The diagrams are for illustration only, which thus is not a limitation of the present disclosure, and wherein:

FIG. 1 illustrates an example network architecture (100) in which or with which embodiments of the present disclosure may be implemented.

FIG. 2 illustrates an example block diagram (200) of a proposed system (108), in accordance with an embodiment of the present disclosure.

FIG. 3 illustrates an exemplary block diagram (300) of a peripheral component interconnect express (PCIe) interface between two processors for sending uplink (UL) Functional Application Platform Interface (FAPI) messages, in accordance with an embodiment of the present disclosure.

FIG. 4 illustrates an exemplary representation (400) of downlink (DL) data transport protocol design, in accordance with an embodiment of the present disclosure.

FIG. 5 illustrates an exemplary representation (500) of UL data transport protocol design, in accordance with an embodiment of the present disclosure.

FIG. 6 illustrates an exemplary sequence diagram (600) for sending data from a first processor to a second processor, in accordance with an embodiment of the present disclosure.

FIG. 7 illustrates an exemplary sequence diagram (700) for sending data from the second processor to the first processor, in accordance with an embodiment of the present disclosure.

FIG. 8 illustrates an exemplary sequence diagram (800) for exchange of FAPI configuration messages between the processors, in accordance with an embodiment of the present disclosure.

FIG. 9 illustrates an exemplary sequence diagram (900) for exchange of DL FAPI slot procedure messages between the processors, in accordance with an embodiment of the present disclosure.

FIG. 10 illustrates an exemplary sequence diagram (1000) for exchange of UL FAPI slot procedure messages between the processors, in accordance with an embodiment of the present disclosure.

FIG. 11 illustrates an exemplary computer system (1100) in which or with which embodiments of the present disclosure may be implemented.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

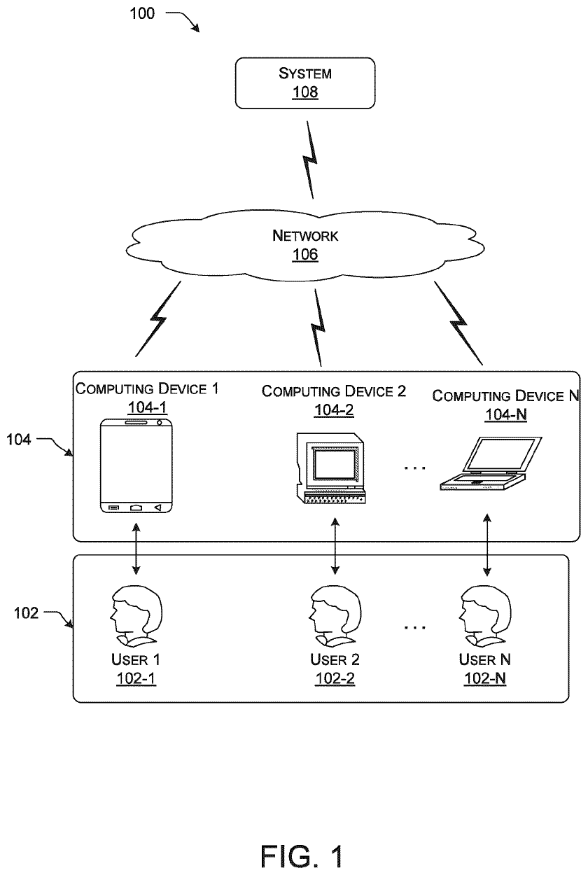

The various embodiments throughout the disclosure will be explained in more detail with reference to FIGS. 1-11.

FIG. 1 illustrates an example network architecture (100) in which or with which embodiments of the present disclosure may be implemented.

As illustrated in FIG. 1, the network architecture (100) may include a system (108). The system (108) may be connected to one or more computing devices (104-1, 104-2 . . . 104-N) via a network (106). The one or more computing devices (104-1, 104-2 . . . 104-N) may be interchangeably specified as a User Equipment (UE) (104) and be operated by one or more users (102-1, 102-2 . . . 102-N). Further, the one or more users (102-1, 102-2 . . . 102-N) may be interchangeably referred as a user (102) or users (102).

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, a desktop, a personal digital assistant, a tablet computer, and a mainframe computer. Additionally, input devices for receiving input from the user (102) such as a touch pad, a touch-enabled screen, an electronic pen, and the like may be used. A person of ordinary skill in the art will appreciate that the computing devices (104) may not be restricted to the mentioned devices and various other devices may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may be associated with a first processor, for example, but not limited to, a host processor and establish a connection between the first processor and a second processor, for example, but not limited to, a Radio Frequency System-on-Chip (RFSoC). Alternatively, the system (108) may be associated with the second processor. The connection between the host processor and the RFSOC may be established by creating a Functional Application Platform Interface (FAPI) integrated with the RFSoC, i.e., the second processor.

In an embodiment, the system (108) may generate an interrupt based on the established connection between the host processor and the RFSoC. The interrupt may be generated when an NXP transport layer of the host processor fills a downlink (DL) buffer region with a message indicating that the data is ready to be read or is set for transmission from a Double Data Rate (DDR) region mapped to a Peripheral Component Interconnect Express (PCIe) Base Address Register (BAR) 0 of the second processor.

In an embodiment, the system (108) may transmit the data that is ready to be read or is set for transmission from the first processor to the second processor based on the generated interrupt. The data may be transmitted between the host processor and the RFSoC by mapping memory sections of the PCIe BAR 0 to the DDR region.

In an embodiment, the system (108) may receive an acknowledgement of the transmitted data from the RFSoC.

In an embodiment, the system (108) may store the data in a buffer region. The buffer region may include, but not limited to, a DL buffer region, a DL queue region, a DL queue control region, a slot indication region, an uplink (UL) buffer region, an UL queue region, and an UL queue control region. The DL buffer region may include a flat memory area written by an NXP transport library and read by a free real-time operating system (RTOS) DL gateway task. The DL queue region may provide pointers to indicate a memory address of the data to be transmitted upon the generation of the interrupt. The DL queue region may include twelve sections with a DL buffer offset variable and a DL buffer length variable in each section. The DL buffer offset variable may point to an address of the DL buffer region which may store the message and the DL buffer length may indicate an actual size of the message. A DL write counter variable may be updated by an NXP FAPI transport layer after transmitting the message over a PCIe bus, and a DL read counter variable may be updated by a FAPI PCIe message handler after decoding and processing the message.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

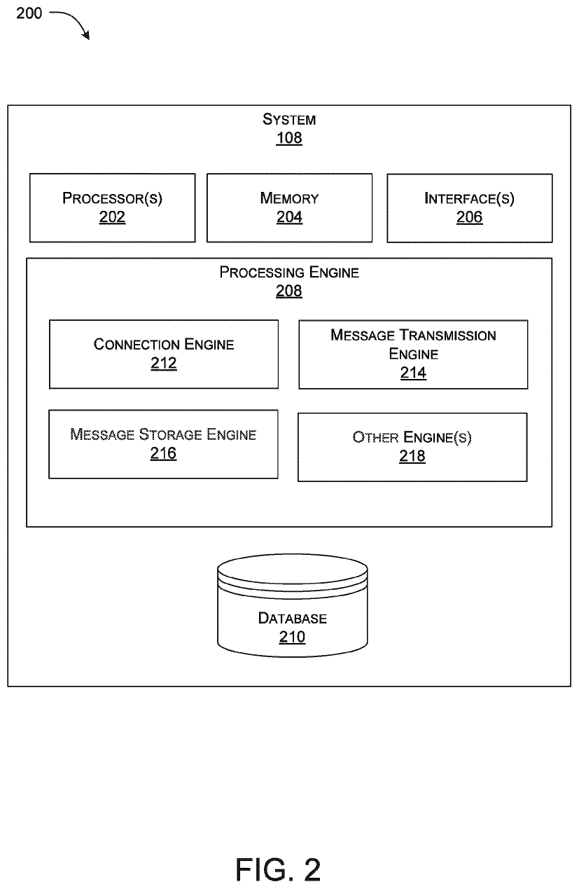

FIG. 2 illustrates an example block diagram (200) of a proposed system (108), in accordance with an embodiment of the present disclosure.

Referring to FIG. 2, the system (108) may include one or more processor(s) (202a, 202b) that may be implemented as one or more microprocessors, microcomputers, microcontrollers, digital signal processors, central processing units, logic circuitries, and/or any devices that process data based on operational instructions. Among other capabilities, the one or more processor(s) (202a, 202b) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may include any non-transitory storage device including, for example, a volatile memory such as a random-access memory (RAM), or a non-volatile memory such as an erasable programmable read only memory (EPROM), a flash memory, and the like.

In an embodiment, the system (108) may include an interface(s) (206). The interface(s) (206) may include a variety of interfaces, for example, interfaces for data input and output (I/O) devices, storage devices, and the like. The interface(s) (206) may also provide a communication pathway for one or more components of the system (108). Examples of such components include, but are not limited to, processing engine(s) (208) and a database (210), where the processing engine(s) (208) may include, but not be limited to, a connection engine (212), a message transmission engine (214), a message storage engine (216), and other engine(s) (218). In an embodiment, the other engine(s) (218) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

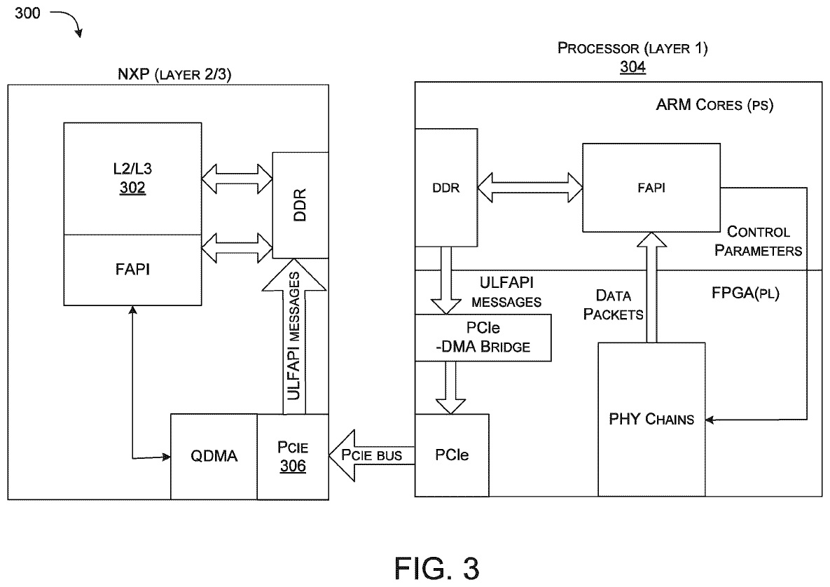

In an embodiment, a first processor (202a) of the one or more processor(s) (202a, 202b) may determine that data is set for transmission from the first processor (202a) (or 302 of FIG. 3) to a second processor (202b) (or 304 of FIG. 3). In an embodiment, the first processor (202a) may copy the data to at least one memory address of the first processor (202a) based on the determination. The at least one memory address of the first processor (202a) may be directly mapped with at least one memory address of the second processor (202b).

In an embodiment, the first processor (202a) may trigger an inter-processor interrupt (IPI) over at least one channel of the second processor (202b) once the data is copied. In order to trigger the IPI over the at least one channel of the second processor (202b), the first processor (202a) may establish connection between the first processor (202a) and the second processor (202b) using the connection engine (212), once the data is copied. Further, the first processor (202a) may generate the IPI based on the established connection. Further, the first processor (202a) may trigger the IPI over the at least one channel of the second processor (202b).

In an embodiment, the first processor (202a) may transmit the data to the second processor (202b), via the IPI, using the message transmission engine (214). The first processor (202a) may receive an acknowledgement in a form of a Message Signalled Interrupt (MSI) over the at least one channel of the second processor (202b), once the second processor (202b) receives the data from the first processor (202a).

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

FIG. 3 illustrates an exemplary block diagram (300) of a PCIe interface between two processors for sending UL FAPI messages, in accordance with an embodiment of the present disclosure. As illustrated in FIG. 3, a PCIe data bus (306) may act as an interface and use a data transfer protocol to establish a connection between the two processors, each of layer 1 (304) and layer 2/3 (302), respectively for transferring the data. Further, the transfer of data may occur upon generation of the interrupt.

Table 1 shows the PCIe transport protocol memory address and different regions. The different regions may be further bifurcated. Further, the Table 1 enlists complete memory sections of the PCIe BAR 0 which may be mapped to the PS DDR region for transfer of the FAPI messages between the L2/L3 (NXP) (302) and the L1 (a processor) (304).

TABLE 1
PCIe Transport Protocol Memory Address

| Memory Address | Size | Description |
|---|---|---|
| 0x5000_0000 | 2 MB | DL Buffer Region |
| 0x5020_0000 | 2 MB | DL Queue Region |
| 0x5040_0000 | 48 B | DL Queue Control Region |
| 0x5040_0030 | 48 B | Slot Indication Region |
| 0x5040_0068 | 2 MB | UL Buffer Region |
| 0x5060_0068 | 2 MB | UL Queue Region |
| 0x5080_0068 | 48 B | UL Queue Control Region |

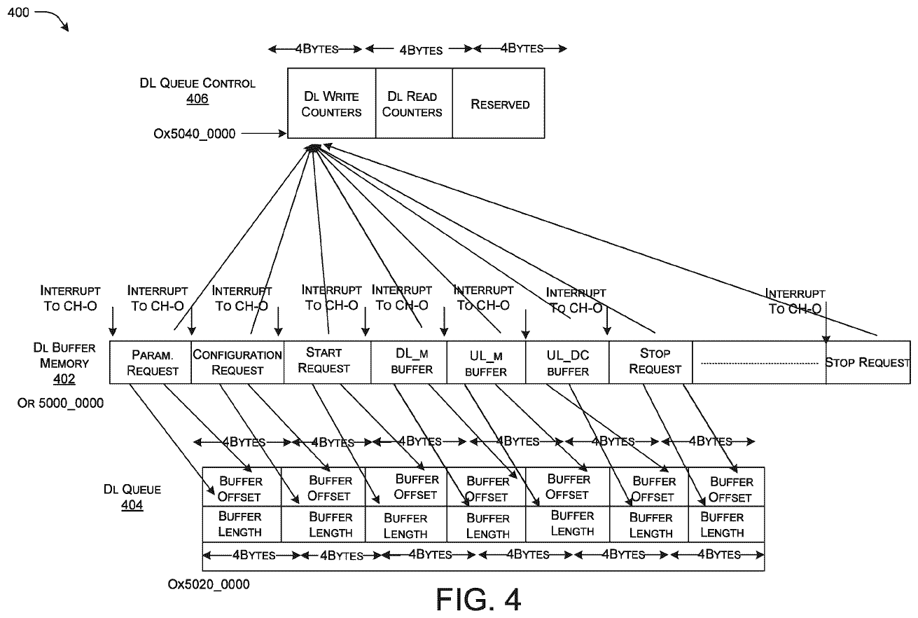

In an embodiment, the PCIe region (306) may be bifurcated into various chunks called as buffer or memory regions as shown in Table 1. The memory regions may store the messages coming in via the UL or the DL based on the memory addresses. Further, pointers may be provided in the DL queue region. The DL queue region may act as a control region and may describe the pointer that points to the data that may have to be sent across in the uplink or in the downlink. The same has been shown in FIG. 4 that illustrates a DL transport protocol design.

FIG. 4 illustrates an exemplary representation (400) of DL data transport protocol design, in accordance with an embodiment of the present disclosure.

With respect to FIG. 4, the DL buffer memory (402) may be defined as 2 Mbytes and depending on a size of a DL FAPI buffer, the DL buffer memory may be divided into sections until the entire 2 Mbytes is completely packed. Each section may simply be a flat memory area to store the DL FAPI messages. The memory area may be written by the NXP transport library and read by the Free RTOS DL gateway task.

The DL queue (404) region may be defined as 2 Mbytes and divided into 12 sections. Each section may consist of two variables, namely the DL buffer offset and the DL buffer length. The DL buffer offset may point to an address of the DL buffer memory, which may hold a DL FAPI message. The DL buffer length may be an actual size of the DL FAPI message.

In an embodiment, the DL queue control region (406) may be defined as a memory area of 48 bytes. The DL queue control region (406) may consist of two variables, namely a DL write counter variable and a DL read counter variable. The DL write counter variable may be updated by a NXP FAPI transport layer, whenever the DL queue region (404) may be populated on sending the DL FAPI message over the PCIe interface (306). Further, the DL read counter variable may be updated by a FAPI PCIe message handler when the DL read counter variable reads the DL queue region (404) to decode and process the DL FAPI message. In addition, a monitoring of the DL write counter variable and the DL read counter variable may be done. If there is a mismatch between the DL write counter variable and the DL read counter variable then an assertion may be implemented on such a condition.

Whenever the NXP transport layer with the appropriate FAPI message fills the DL buffer region (402), the NXP transport layer may raise an interrupt to an inter-processor interrupt (IPI) channel number 0 (CH-0) to indicate that the DL FAPI message may be ready to be read from a PS DDR of the L1 processor (304) mapped to PCIe BAR 0. In an embodiment, it may be stated that for the transfer of data, the interrupt may be generated, and then a Param request (i.e., exemplary messages request) may be sent from L2/L3 processor (302) to the L1 processor (304)-DL, and finally a buffer length may be copied and an offset (i.e., region where the data may be stored) may be provided.

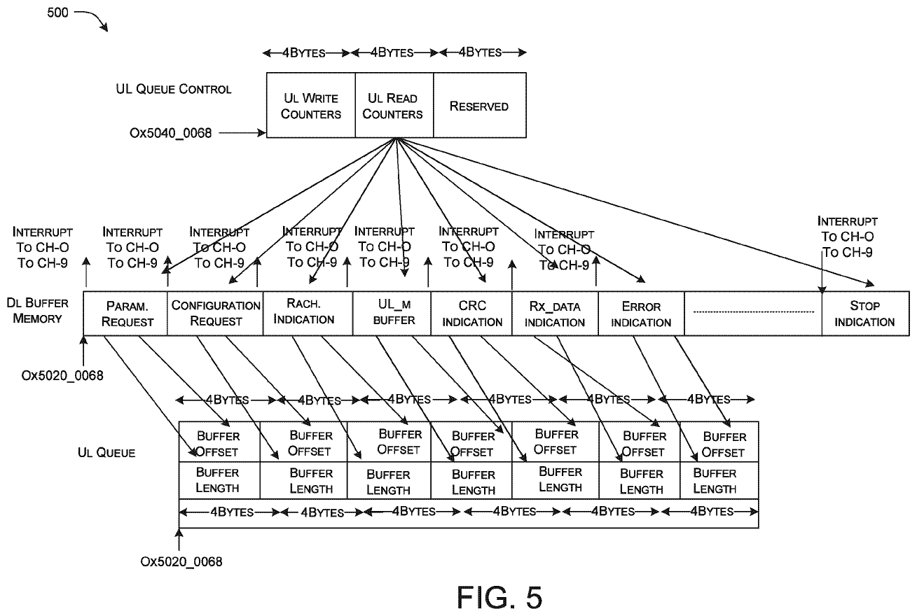

FIG. 5 illustrates an exemplary representation (500) of an UL data transport protocol design, in accordance with an embodiment of the present disclosure. In the UL data transport protocol design, messages may be pushed by L1, L2, and L3. The messages may be stored in the buffer and an actual length and an offset may be kept in a UL queue. Therefore, to process the messages, only the length and the offset may be required for the messages to be picked and processed by the core processor.

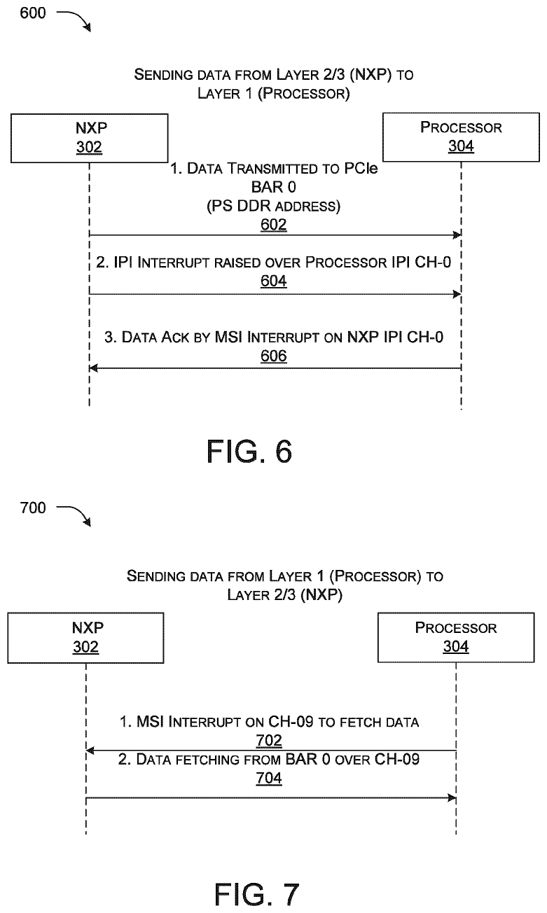

FIG. 6 illustrates an exemplary sequence diagram (600) for sending data from the first processor (302) to the second processor (304), in accordance with an embodiment of the present disclosure. The series of steps involved in sending the data may include: At step 602, when data is ready at the layer 2/3 (NXP) processor (302), the data may be copied to the PCIe BAR 0 address space to be directly mapped with the PS DDR space of the layer 1 processor (304). At step 604, once the data may get copied, the layer 2/3 (NXP) processor (302) may trigger the IPI interrupts over the CH-0 of the layer 2/3 (NXP) processor (302). At step 606, after receiving data from the layer 2/3 (NXP) processor (302), the layer 1 processor (304) may send an acknowledgement in the form of a MSI interrupt over the same CH-0.

FIG. 7 illustrates an exemplary sequence diagram (700) for sending the data from the second processor (304) to the first processor (302), in accordance with an embodiment of the present disclosure. The series of steps involved in sending the data may include: At step 702, when UL FAPI Data is ready at the PS DDR in the layer 1 processor (304), an IPI interrupt over CH-09 may be triggered to the layer 2/3 (NXP) processor (302). At step 704, upon receiving the interrupt, Integrated Services Router (ISR) may post an event to the layer 2/3 (NXP) processor (302), which may fetch the UL FAPI data from the PCIe BAR 0 to the NXP DDR space.

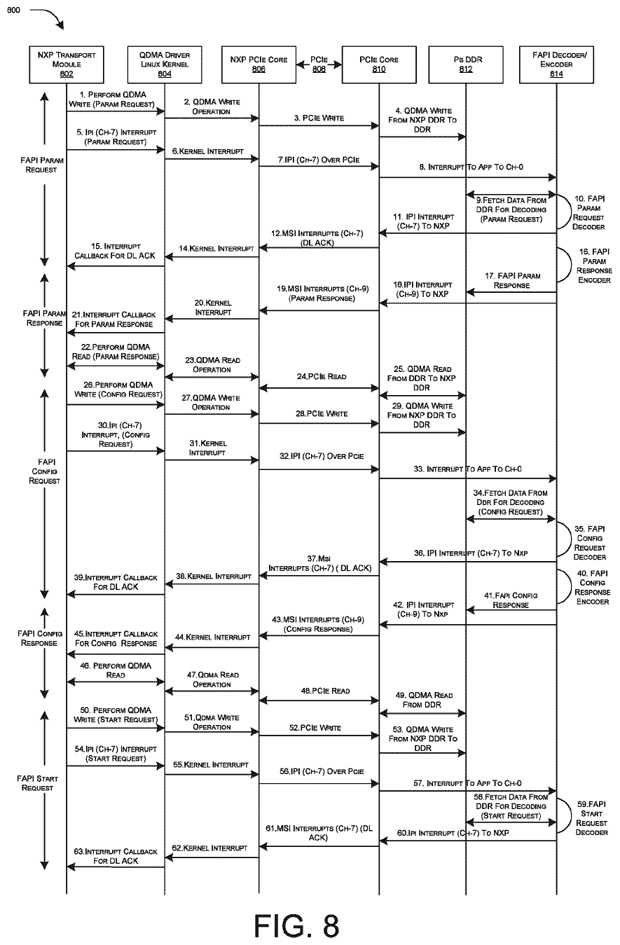

FIG. 8 illustrates an exemplary sequence diagram (800) for exchange of FAPI configuration messages between the processors, in accordance with an embodiment of the present disclosure. In addition, are discussed various modules that are involved in the exchange of these messages. As illustrated in FIG. 8, in step 1, a Param request may be initiated and sent from a NXP transport module (802) to a Queue Direct Memory Access (QDMA) driver operating system (804). In step 2, the QDMA driver operating system (804) may send a QDMA write operation request to an NXP PCIe core (806). In step 3, the NXP PCIe core (806) may transmit a PCIe write request to a PCIe core (810) over the PCIe bus (808). In step 4, the QDMA write operation request from NXP DDR may be sent to the PS DDR (812).

As illustrated in FIG. 8, an IPI (CH-7) interrupt may be generated and sent from the NXP transport module (802) to the QDMA driver operating system (804). Consequently, in step 6, a kernel interrupt may be generated and transmitted from the QDMA driver operating system (804) to the NXP PCIe core (806). The NXP PCIe core (806) may transmit the IPI (CH-7) interrupt to the PCIe core (810) over the PCIe bus (808), in step 7. In step 8, the interrupt to application to CH-0 may be sent from the PCIe core (810) to a FAPI decoder or encoder (814). In steps 9 and 10, the Param request fetched from the PS DDR (812) may be decoded at the FAPI decoder or encoder (814). In step 11, an IPI interrupt (CH-7) to NXP may be sent from the FAPI decoder or encoder (914) to the PCIe core (810). The PCIe core (810) may then transmit MSI interrupts (CH-7) in the form of a DL ACK to the NXP PCIe core (906) over the PCIe bus (808), in steps 12 and 13. The NXP PCIe core (806) may then send the kernel interrupt from the NXP PCIe core (806) to the QDMA driver operating system (804), in step 14.

In step 15, an interrupt callback for DL ACK may be transmitted from the QDMA driver operating system (804) to the NXP transport module (802). In step 16, the FAPI encoder (814) may encode an FAPI Param response and then the FAPI Param response may be transmitted from the FAPI encoder (814) to the PS DDR (812) in step 17. The FAPI encoder (814) may further transmit an IPI interrupt (CH-9) to the PCIe core (810), in step 18. In step 19, the PCIe core (810) may transmit the MSI interrupts (CH-9), as the Param response, to the NXP PCIe core (806) over the PCIe bus (808). The kernel interrupt may be sent from the NXP PCIe core (806) to the QDMA driver operating system (804), in step 20. The QDMA driver operating system (804) may then send an interrupt callback for Param response to the NXP transport module (802), in step 21.

At step 22, a QDMA read operation may be initiated to be performed at step 23 followed by a PCIe read operation at step 24 and a QDMA read operation at step 25. In step 26, a QDMA write configuration request may be sent from the NXP transport module (802) to the QDMA driver operating system (804). Further, at step 27, a QDMA write operation may be sent from the QDMA driver operating system (804) to the NXP PCIe core (806). Further, at step 28, a PCIe write operation may be transmitted from the NXP PCIe core (906) to the PCIe core (810) over the PCIe bus (808). At step 29, the QDMA write operation may be transmitted from the PCIe core (910) to the PS DDR (812). At step 30, an IPI (CH-7) interrupt configuration request may be sent from the NXP transport module (802) to the QDMA driver operating system (804). At step 31, the kernel interrupt may be sent from QDMA driver operating system (804) to the NXP PCIe core (806). At step 32, an IPI (CH-7) may be sent from the NXP PCIe core (806) to the PCIe core (810) over the PCIe bus (808).

At step 33, an interrupt to application to CH-0 may be transmitted from the PCIe core (810) to the FAPI decoder (814). At steps 34 and 35, data may be fetched from the DDR for decoding the configuration request from the FAPI decoder (814). At step 36, an IPI interrupt (CH-7) may be transmitted from the FAPI decoder (814) to the PCIe core (810). At step 37, MSI interrupts CH-7 DL acknowledgement may be transmitted from PCIe core (810) to the NXP PCIe core (806) over the PCIe bus (808). Thereafter, at step 38, the kernel interrupt may be sent from the NXP PCIe core (806) to the QDMA driver operating system (804). The interrupt callback for DL acknowledgement may be transmitted from the QDMA driver acknowledgement (804) to the NXP transport module (802), at step 39.

At steps 40 and 41, a FAPI configuration response may be sent from the FAPI decoder/encoder (814) to the PS DDR (812). At step 42, the IPI interrupt (CH-9) may be transmitted from the FAPI decoder/encoder (914) to the PCIe core (810). At step 43, MSI interrupts (CH-9) may be transmitted from the PCIe core (810) to the NXP PCIe core (806) over the PCIe bus (808). At step 44, the kernel interrupt may be transmitted from the NXP PCIe core (806) to the QDMA driver operating system (804). At step 45, an interrupt callback for configuration response may be sent from the QDMA driver operating system (804) to the NXP transport module (802). At step 46, a QDMA read request may be generated, and at step 47, the QDMA read operation may be transmitted followed by a PCIe read operation at step 48, and QDMA read from DDR to NXP DDR may be performed at step 49.

At step 50, a QDMA write request may be initiated from the NXP transport module (802) to the QDMA driver operating system (804). The QDMA write operation may be initiated from the QDMA driver operating system (804) to the NXP PCIe core (806). At step 52, a PCIe write operation may be transmitted from the NXP PCIe core (806) to the PCIe core (810) over the PCIe bus (808). A QDMA write operation may be transmitted from the PCIe core (810) to the PS DDR (812), at step 53. At step 54, an IPI interrupt (CH-7) may be initiated from the NXP transport module (802) to the QDMA driver operating system (804). At step 55, a kernel interrupt may be sent from the QDMA driver operating system (804) to the NXP PCIe core (806).

At step 56, the IPI (CH-7) may be transmitted from the NXP PCIe core (806) to the PCIe core (810) over the PCIe bus (808). At step 57, interrupt (CH-0) may be transmitted from the PCIe core (810) to the FAPI decoder/encoder (814). At steps 58, 59, and 60, data fetched from DDR for decoding may be transmitted from the FAPI decoder/encoder (814) to the PCIe core (810), along with IPI interrupt CH-7. At step 61, MSI interrupts (CH-7) DL acknowledgement may be transmitted from the PCIe core (810) to the NXP PCIe core (806) over the PCIe bus (808). Further, at step 62, the kernel interrupt may be sent from the NXP PCIe core (806) to the QDMA driver operating system (804). Thereafter, at step 63, the interrupt callback for DL acknowledgement may be transmitted from the QDMA driver operating system (804) to the NXP transport module (802).

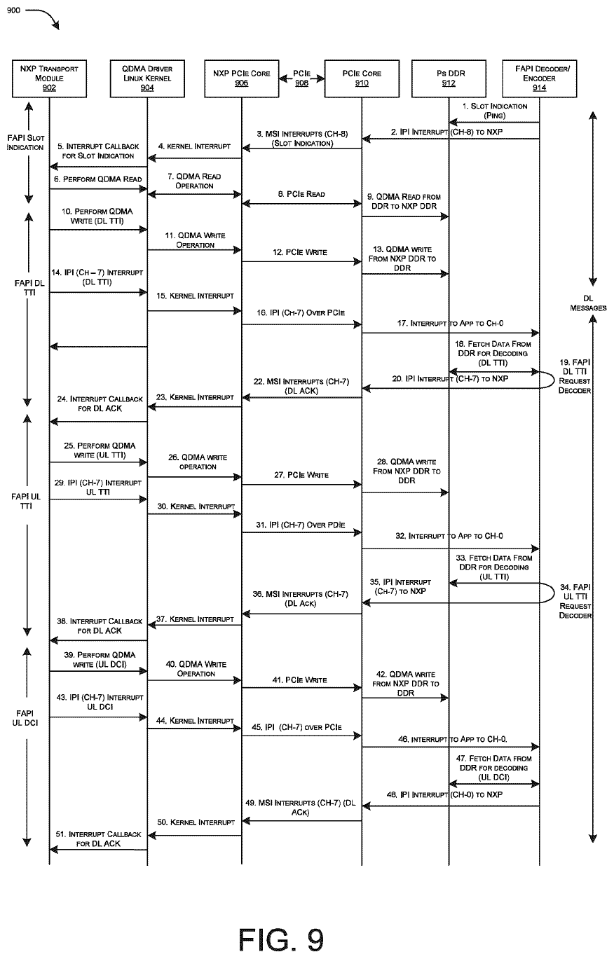

FIG. 9 illustrates an exemplary sequence diagram (900) for exchange of DL FAPI slot procedure messages between the processors, in accordance with an embodiment of the present disclosure. As illustrated in FIG. 9, the FAPI decoder/encoder (914) may initiate a slot indication ping at step 1. At step 2, the FAPI decoder/encoder (914) may send an IPI interrupt (CH-8) to the PCIe core (910). At step 3, MSI interrupts (CH-8) of the slot indication ping may be transmitted from the PCIe core (910) to the NXP PCIe core (906) over the PCIe bus (908). Then, at step 4, a kernel interrupt may be transmitted from the NXP PCIe core (906) to the QDMA driver operating system (904). At step 5, an interrupt callback for the slot indication may be sent from the QDMA driver operating system (904) to the NXP transport module (902). At steps 6, 7, 8, and 9, a QDMA read slot indication may be raised, followed by a QDMA read operation, a PCIe read, and a QDMA read from DDR to NXP DDR. At step 10, a QDMA write (DL TTI) request may be transmitted from the NXP transport module (902) to the QDMA driver operating system (904). At step 11, a QDMA write operation may be transmitted from the QDMA driver operating system (904) to the NXP PCIe Core (906).

At step 12, a PCIe write may be sent from the NXP PCIe Core (906) to the PCIe core (910) over the PCIe bus (908). At step 13, a QDMA write from NXP DDR to DDR may be sent from the PCIe core (910) to the PS DDR (912). At step 14, an IPI CH-7 interrupt may be transmitted from the NXP transport module (902) to the QDMA driver operating system (904). Further, at step 15, a kernel interrupt may be initiated from the QDMA driver operating system (904) to the NXP PCIe core (906). At step 16, IPI CH-7 may be sent from the NXP PCIe core (906) to the PCIe core (910) over the PCIe bus (908). At step 17, an interrupt to application to CH-0 may be sent from the PCIe core (910) to the FAPI decoder/encoder (914). At steps 18 and 19, fetched data from the DDR may be decoded by the FAPI decoder/encoder (914). At step 20, IPI interrupt CH-7 may be sent from the FAPI decoder/encoder (914) to the PCIe core (910).

At steps 21 and 22, MSI interrupts CH-7 may be transferred from the PCIe core (910) to the NXP PCIe core (906) over the PCIe bus (908). At step 23, the kernel interrupt may be sent from the NXP PCIe core (906) to the QDMA driver operating system (904). At step 24, an interrupt callback for DL acknowledgement may be sent from the QDMA driver operating system (904) to the NXP transport module (902). At step 25, a QDMA write request of UL TTI may be sent from the NXP transport module (902) to the QDMA driver operating system (904). At step 26, a QDMA write operation may be sent from the QDMA driver operating system (904) to the NXP PCIe core (906). At step 27, a PCIe write may be sent from the NXP PCIe core (906) to the PCIe core (910) over the PCIe bus (908). At step 28, a QDMA write from NXP DDR to DDR may be sent from the PCIe core (910) to the PS DDR (912).

At step 29, IPI CH-7 interrupt of UL TTI may be sent from the NXP transport module (902) to the QDMA driver operating system (904). At step 30, the kernel interrupt may be sent from the QDMA driver operating system (904) to the NXP PCIe core (906). The IPI CH-7 over PCIe may be sent from the NXP PCIe core (906) to the PCIe core (910) over the PCIe bus (908), at step 31. At step 32, an interrupt to application to CH-0 may be sent from the PCIe core (910) to the FAPI decoder/encoder (914). At steps 33 and 34, fetched data from the DDR may be decoded by the FAPI decoder/encoder (914). At step 35, IPI interrupt CH-7 may be sent from the FAPI decoder/encoder (914) to the PCIe core (910). At step 36, MSI interrupts CH-7 may be transferred from the PCIe core (910) to the NXP PCIe core (906) over the PCIe bus (908).

At step 37, the kernel interrupt may be sent from the NXP PCIe core (906) to the QDMA driver operating system (904). At step 38, an interrupt callback for DL acknowledgement may be sent from the QDMA driver operating system (904) to the NXP transport module (902). At step 40, the QDMA write operation may be sent from the QDMA driver operating system (904) to the NXP PCIe core (906). At step 41, the PCIe write may be sent from the NXP PCIe core (906) to the PCIe core (910) over the PCIe bus (908).

At step 42, the QDMA write from NXP DDR to DDR may be sent from the PCIe core (910) to the PS DDR (912). At step 43, IPI CH-7 interrupt of UL DCI may be sent from the NXP transport module (902) to the QDMA driver operating system (904). At step 44, the kernel interrupt may be sent from the QDMA driver operating system (904) to the NXP PCIe core (906). The IPI CH-7 over PCIe may be sent from the NXP PCIe core (906) to the PCIe core (910) over the PCIe bus (908), at step 45. At step 46, the interrupt to application to CH-0 may be sent from the PCIe core (910) to the FAPI decoder/encoder (914). At step 47, fetched data from the DDR may be decoded by the FAPI decoder/encoder (914). At step 48, the FAPI decoder/encoder (914) may send an IPI interrupt (CH-7) to the PCIe core (910). The MSI interrupts CH-7 may be transferred from the PCIe core (910) to the NXP PCIe Core (906) over the PCIe bus (908), at step 49. At step 50, the kernel interrupt may be sent from the NXP PCIe core (906) to the QDMA driver operating system (904). Finally, at step 51, the interrupt callback for DL acknowledgement may be sent from the QDMA driver operating system (904) to the NXP transport module (902).

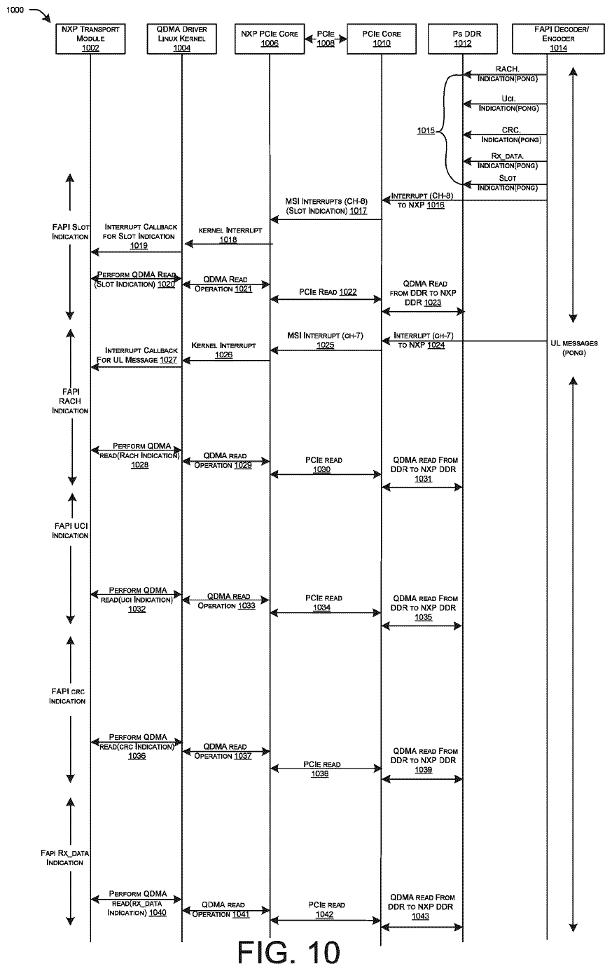

FIG. 10 illustrates an exemplary sequence diagram (1000) for exchange of UL FAPI slot procedure messages between the processors, in accordance with an embodiment of the present disclosure. As illustrated in FIG. 10, the FAPI decoder/encoder (1014) may initiate a Random-Access Channel (RACH) indication, an Uplink Control Information (UCI) indication, a cyclic redundancy check (CRC) indication, a receiver data (Rx_data) indication, and a slot indication at step 1015 to a PS DDR (1012). At step 1016, the FAPI decoder/encoder (1014) may send an interrupt (CH-8) to a PCIe core (1010). At step 1017, the MSI interrupts (CH-8) of the slot indication may be transmitted from the PCIe core (1010) to a NXP PCIe core (1006) over a PCIe bus (1008). At step 1018, a kernel interrupt may be transmitted from the NXP PCIe core (1006) to a QDMA driver operating system (1004). At step 1019, an interrupt callback for the slot indication may be sent from the QDMA driver operating system (1004) to the NXP transport module (1002). At steps 1020, 1021, 1022, and 1023, a QDMA read for slot indication may be raised, followed by a QDMA read operation, a PCIe read, and a QDMA read from DDR to NXP DDR.

At step 1024, an IPI CH-7 interrupt may be transmitted from the FAPI decoder/encoder (1014) to the PCIe core (1010). Further, at step 1025, the MSI interrupt may be initiated from the PCIe core (1010) to the NXP PCIe core (1006) via the PCIe bus (1008). At step 1026, kernel interrupt may be sent from the NXP PCIe core (1006) to the QDMA driver operating system (1004). At step 1027, an interrupt callback for UL message may be sent from the QDMA driver operating system (1004) to the NXP transport module (1002). Further, at steps 1028, 1029, 1030, and 1031, a QDMA read for RACH indication may be raised, followed by the QDMA read operation, the PCIe read, and the QDMA read from the DDR to the NXP DDR may be performed.

Similarly, at steps 1032, 1033, 1034, and 1035, a QDMA read for UCI indication may be raised, followed by the QDMA read operation, the PCIe read, and the QDMA read from the DDR to the NXP DDR may be performed. At steps 1036, 1037, 1038, and 1039, a QDMA read for CRC indication may be raised, followed by the QDMA read operation, the PCIe read, and the QDMA read from the DDR to the NXP DDR may be performed. Further, at steps 1040, 1041, 1042, and 1043, a QDMA read for Rx_data indication may be raised, followed by the QDMA read operation, the PCIe read, and the QDMA read from the DDR to the NXP DDR may be performed.

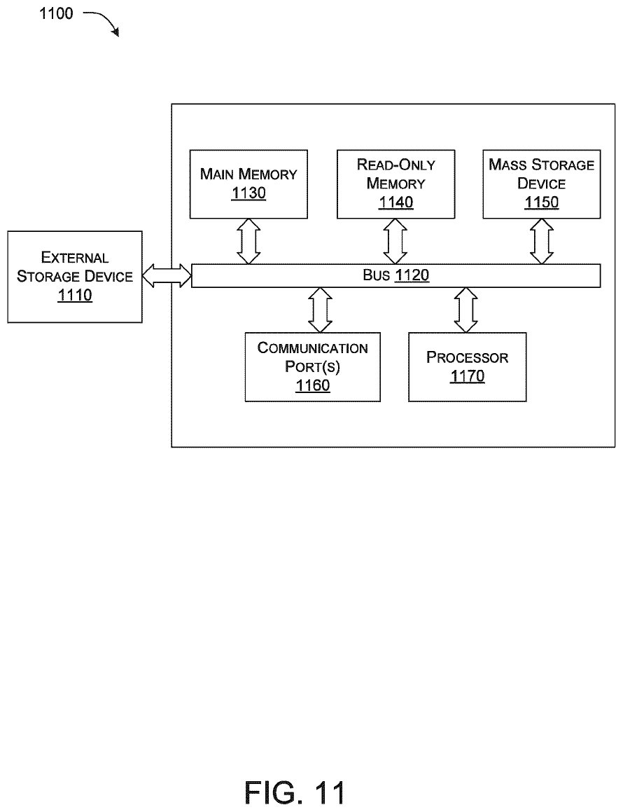

FIG. 11 illustrates an exemplary computer system (1100) in which or with which embodiments of the present disclosure may be utilized, in accordance with embodiments of the present disclosure.

As shown in FIG. 11, the computer system (1100) may include an external storage device (1110), a bus (1120), a main memory (1130), a read-only memory (1140), a mass storage device (1150), a communication port(s) (1160), and a processor (1170). A person skilled in the art will appreciate that the computer system (1100) may include more than one processor and communication ports. The processor (1170) may include various modules associated with embodiments of the present disclosure. The communication port(s) (1160) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (1160) may be chosen depending on a network, such as a Local Area Network (LAN), Wide Area Network (WAN), or any network to which the computer system (1100) connects.

In an embodiment, the main memory (1130) may be Random Access Memory (RAM), or any other dynamic storage device commonly known in the art. The read-only memory (1140) may be any static storage device(s) e.g., but not limited to, a Programmable Read Only Memory (PROM) chip for storing static information e.g., start-up or basic input/output system (BIOS) instructions for the processor (1170). The mass storage device (1150) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (1120) may communicatively couple the processor(s) (1170) with the other memory, storage, and communication blocks. The bus (1120) may be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects the processor (1170) to the computer system (1100).

In another embodiment, operator and administrative interfaces, e.g., a display, keyboard, and cursor control device may also be coupled to the bus (1120) to support direct operator interaction with the computer system (1100). Other operator and administrative interfaces may be provided through network connections connected through the communication port(s) (1160). Components described above are meant only to exemplify various possibilities. In no way should the aforementioned exemplary computer system (1100) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method to enable data transfer between processors, for example, from a host processor to a Radio Frequency System-on-Chip (RFSoC) over a Peripheral Component Interconnect (PCI) bus.

The present disclosure provides a system and a method to establish a communication channel for transfer of data packets between two processors via a Peripheral Component Interconnect express (PCIe) bus.

The present disclosure provides a system and a method to allocate a memory or a memory address to copy the data set for transmission from one processor to another processor, and transfer the data based on the memory address.

The present disclosure provides a system and a method to generate and trigger an inter-processor interrupt (IPI) over a channel of the processor, thereby ensuring successful transfer of the data.

The present disclosure provides an improved communication system.

We claim:

1. A system (108) for data transfer, the system (108) comprising:
processors (202a, 202b); and
a memory (204) operatively coupled with the processors (202a, 202b), wherein the memory (204) comprises processor-executable instructions, which on execution, cause a first processor (202a) of the processors (202a, 202b) to:
determine that data is set for transmission from the first processor (202a) to a second processor (202b) of the processors (202a, 202b);
copy the data to at least one memory address of the first processor (202a) based on the determination, wherein the at least one memory address of the first processor (202a) is directly mapped with at least one memory address of the second processor (202b);
in response to the copying of the data, trigger an inter-processor interrupt (IPI) over at least one channel of the second processor (202b); and
transmit the data to the second processor (202b) via the IPI.

2. The system (108) as claimed in claim 1, wherein the memory (204) comprises processor-executable instructions, which on execution, cause the first processor (202a) to receive an acknowledgement in a form of a Message Signalled Interrupt (MSI) over the at least one channel of the second processor (202b), once the second processor (202b) receives the data from the first processor (202a).

3. The system (108) as claimed in claim 1, wherein the first processor (202a) is to trigger the IPI over the at least one channel of the second processor (202b) by being configured to:
establish a connection between the first processor (202a) and the second processor (202b) once the data is copied;
generate the IPI based on the established connection; and
trigger the IPI over the at least one channel of the second processor (202b) in response to the generation of the IPI.

4. The system (108) as claimed in claim 3, wherein the first processor (202a) is to generate the IPI by determining that a transport layer of the first processor (202a) fills a Downlink (DL) buffer region with a message indicating that the data is set for transmission from a Double Data Rate (DDR) region mapped to a Peripheral Component Interconnect Express (PCIe) Base Address Register (BAR) 0 of the second processor (202b).

5. The system (108) as claimed in claim 1, wherein the at least one memory address of the first processor (202a) corresponds to a Double Data Rate (DDR) region, and wherein the at least one memory address of the second processor (202b) corresponds to a Peripheral Component Interconnect Express (PCIe) Base Address Register (BAR) 0.

6. The system (108) as claimed in claim 1, wherein the memory (204) comprises processor-executable instructions, which on execution, cause the first processor (202a) to store the data in a buffer region, and wherein the buffer region comprises at least one of: a Downlink (DL) buffer region, a DL queue region, a DL queue control region, a slot indication region, an uplink (UL) buffer region, an UL queue region, and an UL queue control region.

7. The system (108) as claimed in claim 6, wherein the DL queue region provides pointers to indicate a memory address of the data to be transmitted upon generation of the IPI.

8. The system (108) as claimed in claim 1, wherein the first processor (202a) is a Layer 2/Layer3 (L2/L3) NXP processor (302), and the second processor (202b) is a Layer 1 (L1) processor (304).

9. A method for data transfer, the method comprising:
determining, by a first processor (202a) associated with a system (108), that data is set for transmission to a second processor (202b);
copying, by the first processor (202a), the data to at least one memory address of the first processor (202a) based on the determination, wherein the at least one memory address of the first processor (202a) is directly mapped with at least one memory address of the second processor (202b);
triggering, by the first processor (202a), an inter-processor interrupt (IPI) over at least one channel of the second processor (202b) in response to copying the data; and
transmitting, by the first processor (202a), the data to the second processor (202b) via the IPI.

10. The method as claimed in claim 9, comprising receiving, by the first processor (202a), an acknowledgement in a form of a Message Signalled Interrupt (MSI) over the at least one channel of the second processor (202b), once the second processor (202b) receives the data from the first processor (202a).

11. The method as claimed in claim 9, wherein triggering, by the first processor (202a), the IPI over the at least one channel of the second processor (202b) comprises:
establishing, by the first processor (202a), a connection between the first processor (202a) and the second processor (202b) once the data is copied;
generating, by the first processor (202a), the IPI based on the established connection; and
triggering, by the first processor (202a), the IPI over the at least one channel of the second processor (202b).

12. The method as claimed in claim 11, wherein generating, by the first processor (202a), the IPI comprises determining that a transport layer of the first processor (202a) fills a Downlink (DL) buffer region with a message indicating that the data is set for transmission from a Double Data Rate (DDR) region mapped to a Peripheral Component Interconnect Express (PCIe) Base Address Register (BAR) 0 of the second processor (202b).

13. The method as claimed in claim 9, wherein the at least one memory address of the first processor (202a) corresponds to a Double Data Rate (DDR) region, and wherein the at least one memory address of the second processor (202b) corresponds to a Peripheral Component Interconnect Express (PCIe) Base Address Register (BAR) 0.

14. The method as claimed in claim 9, comprising storing, by the first processor (202a), the data in a buffer region, wherein the buffer region comprises at least one of: a Downlink (DL) buffer region, a DL queue region, a DL queue control region, a slot indication region, an uplink (UL) buffer region, an UL queue region, and an UL queue control region.

15. The method as claimed in claim 14, wherein the DL queue region provides pointers to indicate a memory address of the data to be transmitted upon generation of the IPI.

16. A non-transitory computer-readable medium comprising processor-executable instructions cause a first processor (202a) to:
determine that data is set for transmission from the first processor (202a) to a second processor (202b);
copy the data to at least one memory address of the first processor (202a) based on the determination, wherein the at least one memory address of the first processor (202a) is directly mapped with at least one memory address of the second processor (202b);
in response to the copying of the data, trigger an inter-processor interrupt (IPI) over at least one channel of the second processor (202b); and
transmit the data to the second processor (202b) via the IPI.
